(19) United States
(12) Patent Application Publication
(10) Pub. No.: US 2011/0181736 A1
(43) Pub. Date: Jul. 28, 2011

(54) PRESENTATION DEVICE

(75) Inventors: Hiroshi Nagatsuma, Nagoya (JP); Yasuo Masui, Miyoshi (JP)

(73) Assignee: ELMO COMPANY, LIMITED, Nagoya (JP)

(21) Appl. No.: 12/945,102

(22) Filed: Nov. 12, 2010

(30) Foreign Application Priority Data
Jan. 27, 2010 (JP) 2010-15036

(51) Int. Cl. H04N 5/225

(52) U.S. Cl. 348/207.1; 348/E05.024

(57) ABSTRACT

The presentation device comprises an operation receiving portion adapted to receive an operation for setting a shooting parameter for the purpose of capturing an image, an image capture portion for capturing an image based on the shooting parameter, a transmitting portion for transmitting the captured image wirelessly to an image output device, and a detecting portion for detecting wireless connection status. The operation receiving portion suspends reception of the operations if the detecting portion detects a lost wireless connection.

### RELATED APPLICATIONS

This application claims priority from Japanese Patent Application No. 2010-15036, filed Jan. 27, 2010, which is herein incorporated by reference in its entirety for all purposes.

### FIELD OF THE INVENTION

The present invention relates to a presentation device adapted to wirelessly transmit a captured image.

### BACKGROUND OF THE INVENTION

Recently, technologies for wirelessly transmitting an image captured by a presentation device to an external image output device have been proposed (see JP-A-1998-262163 and JP-A-2008-271265 for example).

However, with wireless communications, the wireless connection may be suddenly lost due to signal interference, the presence of obstacles, or the like. In such instances, if the user inadvertently operates a control button of the presentation device, there is a risk of an image other than the intended one being displayed when the wireless connection is subsequently reestablished.

### SUMMARY OF THE INVENTION

An object of the present invention is to provide a technique for use in a device adapted to wirelessly transmit an image captured by a presentation device to an external image output device, whereby display of an image other than the intended one can be avoided when the dropped wireless connection is restored.

According to an aspect of the invention there is provided a presentation device adapted to wirelessly transmit an image to an external image output device. the device comprises an operation receiving portion adapted to receive an operation for setting a shooting parameter for capturing an image; an image capture portion adapted to capture an image based on the set shooting parameter; a transmitting portion adopted to transmit the captured image wirelessly to the image output device; and a detecting portion adopted to detect a wireless connection status, wherein the operation receiving portion suspends reception of the operation when the detecting portion detects loss of the wireless connection.

According to the presentation device having this feature, reception of an operation relating to setting of a shooting parameter is suspended if the wireless connection to the image output device is lost. As a result, the image may be displayed with the same shooting parameters before the wireless connection is lost and after it is restored, making it possible to avoid display of an image other than the one intended by the user.

In a preferable embodiment, the presentation device further comprises a power-saving control portion adapted to reduce power consumption by the image capture portion when the detecting portion detects loss of the wireless connection. According to this feature, it is possible to reduce power consumption by the presentation device during the time that the wireless connection is down.

In a preferable embodiment, the image capture portion comprises an autofocus function and/or an auto exposure function; and the power-saving control portion reduces the power consumption by suspending the autofocus function and/or the auto exposure function of the image capture portion. According to this feature, it is possible to halt the motor that is used to drive the lens for the purpose of carrying out an auto-focus function or auto exposure function for example, and power consumption may be effectively reduced thereby.

In a preferable embodiment, the image capture portion comprises a camera portion adapted to optically capture the image, and an image processing portion adapted to receive input of the image from the camera portion and carry out image processing of the image; and the power-saving control portion reduces the power consumption by suspending input of the image from the camera portion to the image processing portion. According to this feature, input of the image from the camera portion to the image processing portion is suspended so that image processing by the image processing portion is suspended. It is possible thereby to reduce power consumption by the image processing portion.

Further embodiments of the invention may provide a method of controlling a presentation device, or a computer program for controlling a presentation device. The computer program may be recorded on a computer-readable recording medium. The recording medium could be a flexible disk, a CD-ROM, a DVD-ROM, a magneto-optical disk, a memory card, a hard disk, or any of various other media for example.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1 is an illustration of the general features of a presentation system, according to an embodiment of the invention;

FIG. 2 is a block diagram depicting the internal configuration of a presentation device, according to an embodiment of the invention;

FIG. 3 is a block diagram depicting the internal configuration of an image output device, according to an embodiment of the invention;

FIG. 4 is a flowchart of a process in the event of a lost wireless connection, according to an embodiment of the invention.

### DETAILED DESCRIPTION

A. General Features of Presentation System.

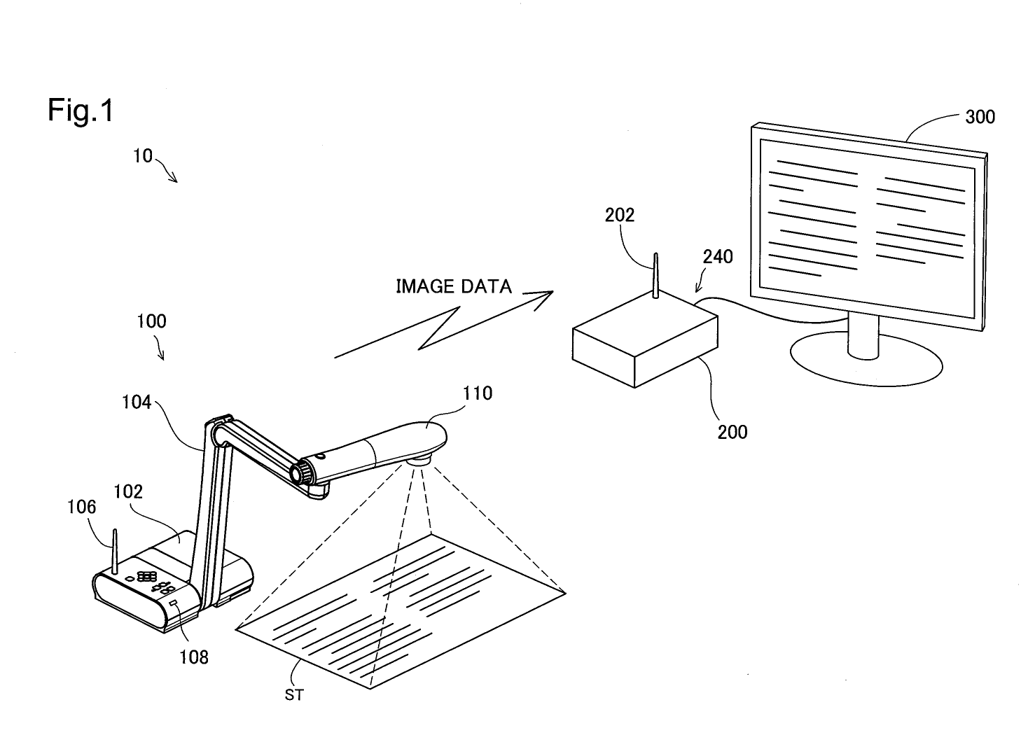

FIG. 1 is an illustration of the general features of a presentation system 10, according to an embodiment of the present invention. The presentation system 10 may include a presentation device 100, an image output device 200, and an external display device 300. A liquid crystal display, a projector, a TV monitor or the like could be employed as the external display device 300 for example. The presentation device 100 of the present embodiment has a function of wirelessly transmitting an image of a document ST captured by a camera head 110 to the image output device 200. When the image output device 200 receives the image wirelessly from the presentation device 100, it then outputs this image to the external display device 300 via an analog RGB interface.

The presentation device 100 comprises a base 102 adapted to be placed on a surface such as a desktop, a support post 104 that extends upward from the base 102, and a camera head 110 mounted to the distal end of the support post 104 for capturing an image of the document ST. The base 102 is also provided with an antenna 106 for wireless communication with the image output device 200. The antenna 106 may be disposed so as to lie exposed to the outside, or disposed within the base 102 or the support post 104. The base 102 is additionally provided with a warning display 108 that lights up if the wireless connection is lost.

The image output device 200 has an antenna 202 for the purpose of communicating wirelessly with the presentation device 100, and an analog RGB output terminal 240 for connection to the external display device 300. The image output device 200 may be provided with additional outputs besides the analog RGB output terminal 240, such as a DVI output terminal, video output terminal, or HDMI output terminal.

B. Internal Configuration of Presentation Device.

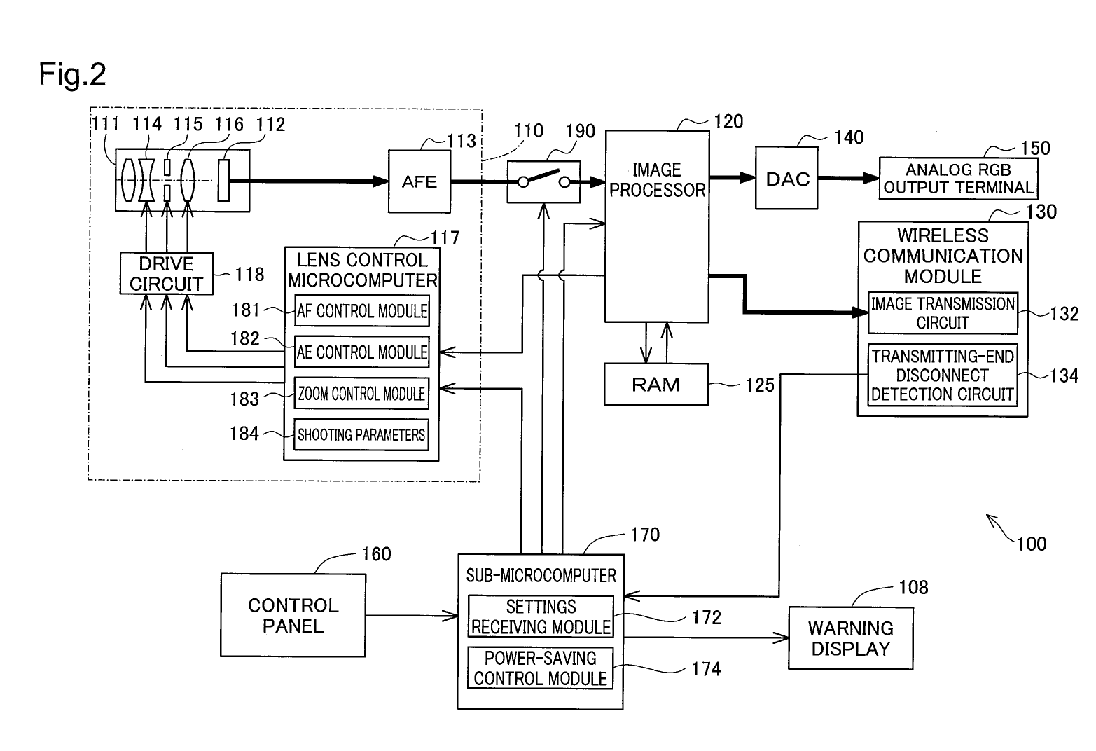

FIG. 2 is a block diagram depicting the internal configuration of the presentation device 100, according to an embodiment of the invention. As illustrated, the presentation device 100 may have a camera head 110, an image processor 120, a RAM 125, a wireless communication module 130, a DAC 140, an analog RGB output terminal 150, a control panel 160, a sub-microcomputer 170, and a warning display portion 108.

The camera head 110 comprises a lens unit 111 for capturing an image of the document ST, a CCD image sensor 112 for converting the light collected by the lens unit 111 to an electrical signal, and an analog front end 113 for converting the analog signal output by the CCD image sensor 112 to a digital signal. It would be possible to employ a CMOS image sensor in place of the CCD image sensor 112.

The lens unit 111 comprises a zoom lens 114, an aperture mechanism 115, and a focusing lens 116. These are driven inside the lens unit 111 by a drive circuit 118 which comprises a motor and driver IC. The drive circuit 118 is controlled by a lens control microcomputer 117.

The lens control microcomputer 117 comprises as internal function modules an autofocus control module 181, an auto exposure control module 182, and a zoom control module 183. On the basis of a luminance signal or the like acquired from the image processor 120, the autofocus control module 181 controls driving of the focusing lens 116 via the drive circuit 118 to carry out the autofocus function. Similarly, on the basis of a luminance signal or the like acquired from the image processor 120, the auto exposure control module 182 controls driving of the aperture mechanism 115 via the drive circuit 118 to carry out the auto exposure function. On the basis of an instruction from the sub-microcomputer 170, discussed later, the zoom control module 183 controls the zoom lens 114 via the drive circuit 118 to carry out the optical zoom function. Parameters for controlling the driving of the focusing lens 116, the zoom lens 114, and the aperture mechanism 115 are saved as shooting parameters in a memory 184 provided to the lens control microcomputer 117.

The picture signal output by the analog front end 113 is input to the image processor 120 via a switch circuit 190. The on/off status of the switch circuit 190 is controlled by the sub-microcomputer 170, discussed later.

The image processor 120 acquires the image from the analog front end 113 and temporarily saves it to the RAM 125. Using the RAM 125 as the working area, it then performs various image processes on the acquired image. Examples of image processes performed by the image processor 120 include white balance adjustment, gamma correction, edge sharpening, and so on. The image data having undergone image processing by the image processor 120 is serially output at a prescribed frame rate (e.g. 30 frames per second) to the wireless communication module 130. The image data output to the wireless communication module 130 by the image processor is uncompressed data of XGA (1024 768 pixels) resolution for example, containing data of 24 bits (8 bits each for R, G, and B, for a total of 24 bits) on each pixel. The camera head 110 and the image processor 120 discussed above correspond to the “image capture portion” herein.

The wireless communication module 130 may be a hardware module incorporating a microcomputer and wireless communication IC. The wireless communication module of the present embodiment communicates with the image output device 200 via the antenna 106 (FIG. 1), on the basis of the wireless communications standard known as WHDI(Trademark) (Wireless Home Digital Interface). However, a different standard besides WHDI, such as Wireless HD(Trademark), IEEE 802.11g or n, or some other wireless LAN standard could be selected as the wireless communications standard instead.

The wireless communication module 130 comprises an image transmission circuit 132 and a transmitting-end disconnect detection circuit 134. The image transmission circuit 132 has the function of transmitting image data input from the image processor 120 to the image output device 200, based on the WHDI standard. The transmitting-end disconnect detection circuit 134 has the function of monitoring the wireless connection status between the presentation device 100 and the image output device 200, and notifying the sub-microcomputer 170, discussed later, of the connection status. If the wireless connection is up, it notifies the sub-microcomputer 170 through a signal representing wireless connection (hereinafter termed a “connect signal”), whereas if the wireless connection is down, it notifies the sub-microcomputer 170 through a signal representing a lost wireless connection (hereinafter termed a “disconnect signal”).

Besides the wireless communication module 130, the DAC 140 is also connected to the image processor 120. The image processor 120 outputs a digital signal representing the image-processed image to the DAC 140. The DAC 140 performs D/A conversion of the digital signal and generates an analog RGB signal. The analog RGB signal so generated is output to the analog RGB output terminal 150. That is, in addition to its function of transmitting images wirelessly, the presentation device 100 of the present embodiment is able to output images to an external display device directly connected to the presentation device 100 via the analog RGB output terminal 150. The presentation device 100 may be provided with additional outputs besides the analog RGB output terminal 240, such as a DVI output terminal, video output terminal, or HDMI output terminal for example.

The control panel 160 is provided on the base 102 of the presentation device 100. The control panel 160 is provided for example with a zoom button for optical zoom of the camera head 110, and with buttons for selecting image processes to be carried out by the image processor 120.

The sub-microcomputer 170 is connected to the control panel 160. The sub-microcomputer 170 has as internal function modules a settings receiving module 172 and a power-saving control module 174. The settings receiving module 172 receives from the control panel 160 various operations relating to image shooting parameters, such as the zoom factor, the autofocus function on/off setting, and the auto exposure function on/off setting. Upon receiving one of these operations, the settings receiving module 172 outputs a signal reflecting the operation that was input to the lens control microcomputer 117.

The power-saving control module 174 has the function of placing the presentation device 100 in power save mode upon receipt of a disconnect signal from the disconnect detection circuit 134 of the wireless communication module 130. Specifically, the power-saving control module 174 suspends the autofocus function, the auto exposure function, and the zoom function of the camera head 110, and additionally controls the switch circuit 190 to suspend input of the picture signal from the camera head 110 to the image processor 120 in order to place the presentation device 100 in power save mode. If the autofocus function, the auto exposure function, and the zoom function are suspended, driving of the motor used to accomplish these functions ceases, making reduced power consumption possible. When input of the picture signal from the camera head 110 to the image processor 120 is suspended, the RGB signals input to the image processor 120 all go to zero, and accordingly there is substantially no image processing by the image processor 120, making it possible to reduce power consumption by the image processor 120.

The warning display 108 (see FIG. 1) is connected to the sub-microcomputer 170. When the sub-microcomputer 170 receives a disconnect signal from the transmitting-end disconnect detection circuit 134 in the wireless communication module 130, the warning display 108 turns on.

C. Internal Configuration of Image Output Device:

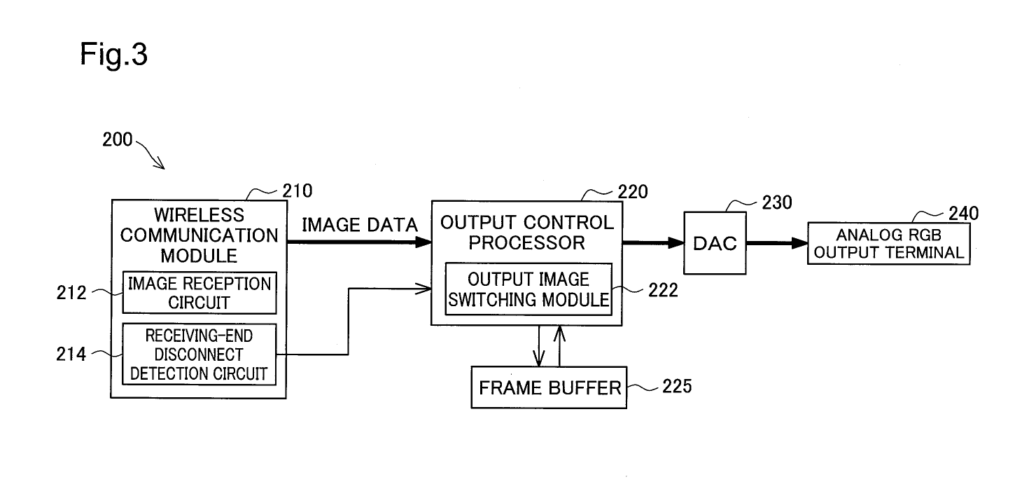

FIG. 3 is a block diagram depicting the internal configuration of the image output device 200, according to an embodiment of the present invention. The image output device 200 comprises a wireless communication module 210, an output control processor 220, a DAC 230, and an analog RGB output terminal 240.

Like the wireless communication module 130 in the presentation device 100, the wireless communication module 210 is a hardware module that incorporates a microcomputer or wireless communication IC, and communicates with the presentation device 100 via the antenna 202 on the basis of the WHDI standard.

The wireless communication module 210 has an image reception circuit 212 and a receiving-end disconnect detection circuit 214. The image reception circuit 212 has the function of receiving image data transmitted from the presentation device 100, and transferring the received image data to the output control processor 220. The receiving-end disconnect detection circuit 214 has the function of monitoring the wireless connection status between the presentation device 100 and the image output device 200, and detecting a dropped connection. If the receiving-end disconnect detection circuit 214 detects a dropped connection, it sends a disconnect signal to the output control processor 220, discussed later.

The output control processor 220 acquires the image data from the wireless communication module 210 and temporarily saves the acquired image data to a frame buffer 225. The image data saved to the frame buffer 225 is read by the output control processor 220 at a prescribed frame rate (e.g. 60 frames per second), and transferred to the DAC 230. In the DAC 230 the picture signal representing the image data undergoes D/A conversion to generate an analog RGB signal. The analog RGB signal so generated is output to the external display device 300 through the analog RGB output terminal 240.

The output control processor 220 has an output image switching module 222 as an internal function module. In the event that a disconnect signal is received from the receiving-end disconnect detection circuit 214 of the wireless communication module 210, the output image switching module 222 carries out a function whereby writing of image data to the frame buffer 225 is suspended, and the image data stored just prior to the time that the connection was lost is held in the buffer. By holding the image data in the frame buffer 225 in this way, the same image continues to be output to the external display device 300 at the frame rate mentioned above. Thus, for the duration of the dropped connection, the image output by the output device 200 is that captured just prior to loss of the wireless connection and output as a still image to the image output device 200.

D. Process in the Event of Dropped Wireless Connection:

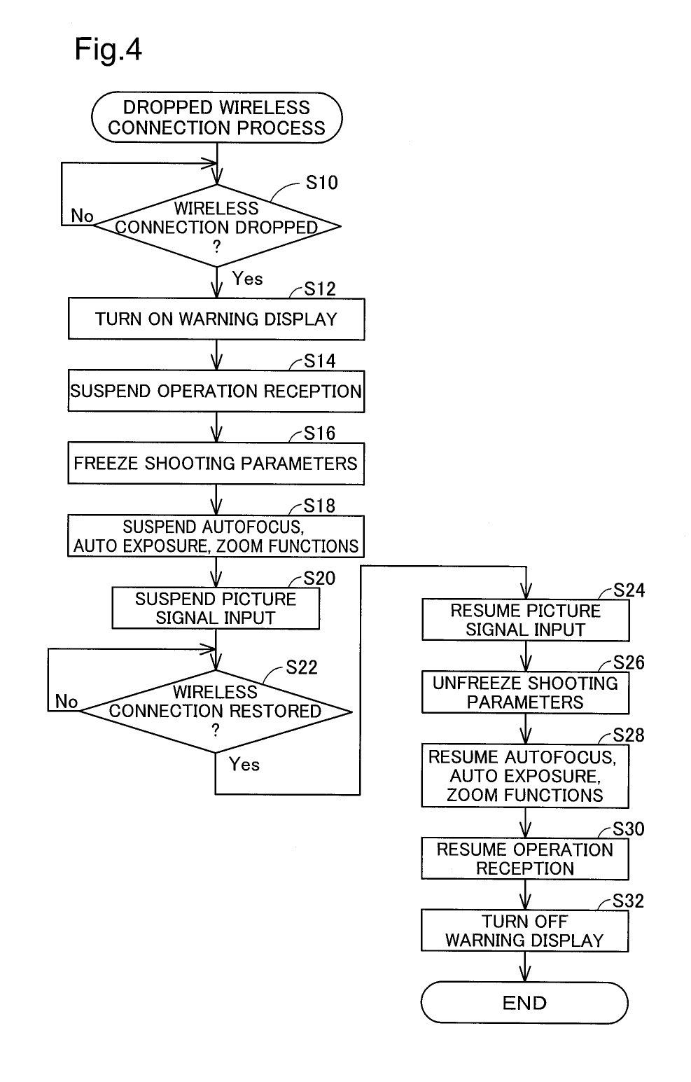

FIG. 4 is a flowchart, according to an embodiment of the present invention, of a dropped wireless connection process that is executed by the sub-microcomputer 170 of the presentation device 100. The process is one that may be executed repeatedly on an ongoing basis during operation of the presentation device 100.

When this lost wireless connection process is initiated, the sub-microcomputer 170 first decides whether the wireless connection is disconnected (Step S10). If the sub-microcomputer 170 received a disconnect signal from the transmitting-end disconnect detection circuit 134 of the wireless communication module 130, it decides that the wireless connection was disconnected. If the sub-microcomputer 170 decides that the wireless connection is not disconnected, it continues to stand by. On the other hand, if the sub-microcomputer 170 decides that the wireless connection was disconnected, it first lights up the warning display 108 (Step S12). This notifies the user that the wireless connection is disconnected. Next, the sub-microcomputer 170 suspends reception of operations relating to setting of shooting parameters by the settings receiving module 172 via the control panel 160 (Step S14), and presents a prescribed command to the lens control microcomputer 117 to freeze the shooting parameters (Step S16).

Once the shooting parameters are frozen, the sub-microcomputer 170 presents a prescribed command to the lens control microcomputer 117 through the power-saving control module 174, to suspend the autofocus function, the auto exposure function, and the zoom function (Step S18). Then, through the power-saving control module 174, the sub-microcomputer 170 controls the switch circuit 190 and suspends input of the picture signal from the camera head 110 to the image processor 120 (Step S20).

Once the series of processes discussed above is completed, the sub-microcomputer 170 decides whether the wireless connection was restored (Step S22). If the sub-microcomputer 170 received a connect signal from the transmitting-end disconnect detection circuit 134 of the wireless communication module 130, it decides that the wireless connection was restored. If the sub-microcomputer 170 decides that the wireless connection was not restored, it continues to stand by until the wireless connection is restored.

Upon deciding that the wireless connection is restored, the sub-microcomputer 170 controls the switch circuit 190 through the power-saving control module 174 and resumes input of the picture signal from the analog front end 113 to the image processor 120 (Step S24). It then presents a prescribed command to the lens control microcomputer 117 to unfreeze the shooting parameters (Step S26), and re-enables the autofocus function, the auto exposure function, and the zoom function on the basis of these shooting parameters (Step S28).

Once the autofocus function, the auto exposure function, and the zoom function are re-enabled, the sub-microcomputer 170 re-enables reception of operations relating to setting of shooting parameters by the settings receiving module 172 via the control panel 160 (Step S30). Finally, the warning display 108 turns off (Step S32).

According to the presentation device 100 of the embodiment described above, if the wireless connection to the image output device 200 is lost, reception of operations relating to setting of shooting parameters of images from the user is suspended, and the shooting parameters are frozen. Thus, even if the user inadvertently operates the control panel 160 of the presentation device 100 while the wireless connection is down, the image that is output when the wireless connection is restored is one captured with the same shooting parameters as the image prior to loss of the wireless connection. It is thus possible to avoid situations in which an image other than the one intended by the user is displayed when the wireless connection is restored.

Additionally, in the presentation device 100 of the present embodiment, when the wireless connection to the image output device 200 is lost, the autofocus function, the auto exposure function, and the zoom function are suspended, and input of the picture signal from the camera head 110 to the image processor 120 is suspended as well. The power consumption of the presentation device 100 can thus be reduced while the wireless connection is down. As discussed previously, according to the present embodiment, in order to avoid situations in which an image other than the one intended by the user is displayed when the wireless connection is restored, during the time that the wireless connection is down, reception of operations by the user is suspended. Thus, the user experiences no inconvenience from suspension of the autofocus function, the auto exposure function, and the zoom function. Moreover, according to the present embodiment, updating of the frame buffer 225 by the image output device 200 is suspended during the time that the wireless connection is down, so a still image is output by the image output device 200. Thus, despite the fact that input of the picture signal to the image processor 120 is suspended, the display screen does not suddenly go blank.

While the present invention has been shown herein in terms of a preferred embodiment, no limitation of the invention to this particular embodiment is intended, and various other features may be employed without departing from the spirit thereof. For example, whereas in the embodiment above, the autofocus function, the auto exposure function, and the zoom function, as well as the function of inputting the picture signal from the camera head 110 to the image processor 120, are all suspended for the duration that the wireless connection is down, any one or more of these functions may be suspended.

Moreover, according to the preceding embodiment, power consumption by the image processor 120 is reduced by suspending input of the picture signal from the camera head 110 to the image processor 120. However it would be possible, in an alternate embodiment, to instead reduce power consumption by the image processor 120 by suspending the power supply to the image processor 120, or by slowing the operating clock of the image processor 120. However, where the image processor 120 is of a type that requires some time to restart, it is preferable to provide the image processor 120 with a continuous supply of power during the time that the wireless connection is down as well. The reason is that if a constant power supply is maintained while the wireless connection is down, an image may be output promptly once the wireless connection is restored.

In alternate embodiments the presentation device 100 of the embodiment may run on a commercial power supply, or run on a battery. Where the device runs on a battery, consumption of battery power while the wireless connection is down may be avoided through the power save function described above.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

What is claimed is:

1. A presentation device adapted to wirelessly transmit an image to an external image output device, comprising:
an operation receiving portion adapted to receive an operation for setting a shooting parameter for capturing an image;
an image capture portion adapted to capture an image based on the set shooting parameter;
a transmitting portion adopted to transmit the captured image wirelessly to the image output device; and
a detecting portion adopted to detect a wireless connection status,
wherein the operation receiving portion suspends reception of the operation when the detecting portion detects loss of the wireless connection.

2. The presentation device according to claim 1 further comprising
a power-saving control portion adapted to reduce power consumption by the image capture portion when the detecting portion detects loss of the wireless connection.

3. The presentation device according to claim 2, wherein
the image capture portion comprises an autofocus function; and
the power-saving control portion reduces the power consumption by suspending the autofocus function of the image capture portion.

4. The presentation device according to claim 2, wherein
the image capture portion comprises an auto exposure function; and
the power-saving control portion reduces the power consumption by suspending the auto exposure function of the image capture portion.

5. The presentation device according to claim 2, wherein
the image capture portion comprises a camera portion adapted to optically capture the image, and an image processing portion adapted to receive input of the image from the camera portion and perform image processing of the image; and
the power-saving control portion reduces the power consumption by suspending input of the image from the camera portion to the image processing portion.
